(19) United States
(12) Patent Application Publication
(10) Pub. No.: US 2015/0254672 A1
(43) Pub. Date: Sep. 10, 2015

(54) PROCESSING AUTHORIZATION REQUESTS

(71) Applicant: Visa Europe Limited, London (GB)

(72) Inventors: Christian HUESCH, London (GB); Georges YARYURA, London (GB); Michael HOFFMANN, London (GB); Katharina FUHRMANN, London (GB)

(21) Appl. No.: 14/718,989

(22) Filed: May 21, 2015

Related U.S. Application Data
(63) Continuation of application No. PCT/GB2013/050677, filed on Mar. 15, 2013.

(30) Foreign Application Priority Data
Nov. 22, 2012 (GB) 1221029.0

(51) Int. Cl. G06Q 20/40

(52) U.S. Cl. CPC G06Q 20/4097

(57) ABSTRACT

Systems, methods and computer programs for use in processing payment authorization requests for payment transactions to be conducted via a data communications network. At a trusted intermediary system, data indicative of the user having been authenticated by a first authentication process conducted between the user and a data communication interface associated with a bank data processing system is received via a data communication network. In response to the receipt of the authentication-indicative data, a user account corresponding to one or more transactional accounts held by a user at the bank data processing system is activated. Payment data associated with the one or more transactional accounts is stored in a data store in association with the user account. Following a subsequent authentication of the user by a second authentication process conducted between the user and the trusted intermediary system, the stored payment data is retrieved from the data store for use in processing at least one payment authorization request involving the user.

### CROSS-REFERENCE TO RELATED APPLICATIONS

This application is a continuation of International Application No. PCT/GB2013/050677, filed Mar. 15, 2015, which claims the benefit of Foreign Patent Application No. GB1221029.0, filed Nov. 22, 2012. Each of the above-referenced patent applications is incorporated by reference in its entirety.

### BACKGROUND OF THE INVENTION

1. Field of the Invention

This application relates to processing authorization requests, particularly to processing payment authorization requests for payment transactions to be conducted via a data communications network.

2. Description of the Related Technology

Various types of online payment systems are known. Some users are not comfortable making online payments via certain existing online payment systems. However, many of such users are relatively comfortable instructing specific payments from their bank online, which provides an online banking website for such purposes. In this case the payment process proceeds as a bill-payment type transfer directly from the user's transactional account (e.g. a current account or checking account) held by the bank data processing system. This type of online payment is relatively secure, typically using sophisticated authentication techniques, but is rather inconvenient in that it involves a significant amount of user interaction.

For example, to make this type of online payment, the user visits their online banking website, enters their online banking login details (which may require, for example, two fields to be completed), selects their current account, selects a money transfer option, fills in the transaction details manually (which may require the user to complete, for example, five fields including approximately eighty digits) and then confirm the transaction via a one-time passcode, for example from a paper list. This approach may require around fifteen user input selections and around one hundred digits to be input.

It would be desirable to provide improved arrangements for online payments.

### SUMMARY

In accordance with a first embodiment, there is provided a method for use in processing payment authorization requests for payment transactions to be conducted via a data communications network, the method comprising, at a trusted intermediary system: receiving data indicative of the user having been authenticated by a first authentication process conducted between the user and a data communication interface associated with a bank data processing system via a data communication network; activating, in response to the receipt of the authentication-indicative data, a user account corresponding to one or more transactional accounts held by a user at the bank data processing system; storing payment data associated with the one or more transactional accounts in a data store in association with the user account; and retrieving, following a subsequent authentication of the user by a second authentication process conducted between the user and the trusted intermediary system, the stored payment data from the data store for use in processing at least one payment authorization request involving the user.

According to a second embodiment, there is provided a system for use in processing payment authorization requests for payment transactions to be conducted via a data communications network, the system comprising a trusted intermediary system configured for: receiving data indicative of the user having been authenticated by a first authentication process conducted between the user and a data communication interface associated with a bank data processing system via a data communication network; activating, in response to the receipt of the authentication-indicative data, a user account corresponding to one or more transactional accounts held by a user at the bank data processing system; storing payment data associated with the one or more transactional accounts in a data store in association with the user account; and retrieving, following a subsequent authentication of the user by a second authentication process conducted between the user and the trusted intermediary system, the stored payment data from the data store for use in processing at least one payment authorization request involving the user.

According to a third embodiment, there is provided a computer program arranged to perform a method for use in processing payment authorization requests for payment transactions to be conducted via a data communications network, the method comprising, at a trusted intermediary system: receiving data indicative of the user having been authenticated by a first authentication process conducted between the user and a data communication interface associated with a bank data processing system via a data communication network; activating, in response to the receipt of the authentication-indicative data, a user account corresponding to one or more transactional accounts held by a user at the bank data processing system; storing payment data associated with the one or more transactional accounts in a data store in association with the user account; and retrieving, following a subsequent authentication of the user by a second authentication process conducted between the user and the trusted intermediary system, the stored payment data from the data store for use in processing at least one payment authorization request involving the user.

According to a fourth embodiment, there is provided a method for use in processing payment authorization requests for payment transactions to be conducted via a data communications network, the method comprising, at a bank data processing system: conducting a first authentication process involving the user and the bank data processing system; and transmitting data, indicative of the user having been authenticated by the first authentication process, to activate a user account for the user in a trusted intermediary system, the trusted intermediary system being arranged to store payment data associated with one or more transactional accounts held by a user at the bank data processing system in a data store in association with the activated user account and to retrieve, following a subsequent authentication of the user by a second authentication process conducted between the user and the trusted intermediary system, the stored payment data from the data store for use in processing at least one payment authorization request involving the user.

According to a fifth embodiment, there is provided a system for use in processing payment authorization requests for payment transactions to be conducted via a data communications network, the system comprising a bank data processing system, the bank data processing system being arranged for: conducting a first authentication process involving the user and the bank data processing system; and transmitting data, indicative of the user having been authenticated by the first authentication process, to activate a user account for the user in a trusted intermediary system, the trusted intermediary system being arranged to store payment data associated with one or more transactional accounts held by a user at the bank data processing system in a data store in association with the activated user account and to retrieve, following a subsequent authentication of the user by a second authentication process conducted between the user and the trusted intermediary system, the stored payment data from the data store for use in processing at least one payment authorization request involving the user.

According to a sixth embodiment, there is provided a computer program being arranged to perform a method for use in processing payment authorization requests for payment transactions to be conducted via a data communications network, the method comprising, at a bank data processing system: conducting a first authentication process involving the user and the bank data processing system; and transmitting data, indicative of the user having been authenticated by the first authentication process, to activate a user account for the user in a trusted intermediary system, the trusted intermediary system being arranged to store payment data associated with one or more transactional accounts held by a user at the bank data processing system in a data store in association with the activated user account and to retrieve, following a subsequent authentication of the user by a second authentication process conducted between the user and the trusted intermediary system, the stored payment data from the data store for use in processing at least one payment authorization request involving the user.

Further features and advantages of embodiments will become apparent from the following description of embodiments, given by way of example only, which is made with reference to the accompanying drawings.

### BRIEF DESCRIPTION OF THE DRAWINGS

FIG. 1 is a schematic diagram showing a payment system according to one or more embodiments of the present invention.

FIG. 2 is a schematic flow diagram showing the flow of data using use of a payment system according to one or more embodiments of the present invention.

FIGS. 3a, 3b, 3c and 3d show representations of content displayed to a user during use of a payment system according to one or more embodiments of the present invention.

FIG. 4 is a schematic flow diagram showing the flow of data using use of a payment system according to one or more embodiments of the present invention.

FIG. 5 shows a representation of content displayed to a user during use of a payment system according to one or more embodiments of the present invention.

FIG. 6 is a schematic flow diagram showing the flow of data using use of a payment system according to one or more embodiments of the present invention.

FIGS. 7a and 7b show representations of content displayed to a user during use of a payment system according to one or more embodiments of the present invention.

FIG. 8 is a schematic flow diagram showing the flow of data using use of a payment system according to one or more embodiments of the present invention.

FIGS. 9a, 9b, 9c and 9d show representations of content displayed to a user during use of a payment system according to one or more embodiments of the present invention.

FIGS. 10a and 10b show representations of content displayed to a user during use of a payment system according to one or more embodiments of the present invention.

FIG. 11 is a schematic block diagram showing components of the trusted intermediary system according to one or more embodiments of the present invention.

### DETAILED DESCRIPTION OF CERTAIN INVENTIVE EMBODIMENTS

Prior to a detailed description referencing the Figures, embodiments will first be described in summary form.

In accordance with a first embodiment, there is provided a method for use in processing payment authorization requests for payment transactions to be conducted via a data communications network, the method comprising, at a trusted intermediary system: receiving data indicative of the user having been authenticated by a first authentication process conducted between the user and a data communication interface associated with a bank data processing system via a data communication network; activating, in response to the receipt of the authentication-indicative data, a user account corresponding to one or more transactional accounts held by a user at the bank data processing system; storing payment data associated with the one or more transactional accounts in a data store in association with the user account; and retrieving, following a subsequent authentication of the user by a second authentication process conducted between the user and the trusted intermediary system, the stored payment data from the data store for use in processing at least one payment authorization request involving the user.

The account may thus be activated in response to the authentication-indicative data, which shows that the user has authenticated with the bank data processing system; this manner of activation of a user account at the trusted intermediary provides a high level of confidence to users of the system. Moreover, a user need not enter the payment data manually, since they may be received from the bank data processing system or may be generated in the trusted intermediary system. This may reduce the likelihood of errors that may be present as a result of the user manually entering their payment data incorrectly. In some cases, the user may not be able to determine the payment data themselves and indeed the user may not have access to the payment data at all.

Whilst the bank data processing system may be configured to provide the authentication-indicative data following authentication of the user by the first authentication process, subsequent payment processing times may be reduced since the user need not authenticate with the bank data processing system every time of using that process. This may be significant where the first authentication process involves the use of physical authentication devices such as mobile telephones, security tokens or cards with embedded chips, which the user does not always have readily available.

In some embodiments, the second authentication process may involve the use of fewer authentication factors than the first authentication process. This may improve user experience in that the user may not be required to go through the same level of authentication required for the first authorization process as they are for the second authentication process. Checkout times and the amount of user interaction for completing payment may also be reduced. Some embodiments may comprise receiving one or more first authentication process credentials for use in the first authentication process. This may increase the trust relationship with the user by virtue of the user sharing their first authentication process credentials (for example online banking credential(s)) with the trusted intermediary system.

Some embodiments may comprise transmitting the one or more first authentication process credentials via an interface to a bank data processing system. This may improve user experience by making it more convenient for a user.

In some embodiments, the interface may use an online banking protocol. In some embodiments, the protocol may be, or may be based on, the Financial Transaction Services (FinTS) protocol. In some cases, the appearance of the interface may be standardized across multiple bank data processing systems. The user may therefore be presented with a more consistent, bank-independent interface appearance which provides some degree of familiarity to the user.

Some embodiments may comprise transmitting the received one or more first authentication process credentials to the bank data processing system. In some embodiments, an interface may be established to the bank data processing system, which uses an online banking protocol. In some embodiments, the protocol may be, or may be based on, the FinTS protocol.

Some embodiments may comprise receiving bank identification data to identify the bank data processing system prior to said receiving of the authentication-indicative data from the bank data processing system.

Some embodiments may comprise receiving one or more first authentication process credentials for use in the first authentication process prior to said receiving of the authentication-indicative data from the bank data processing system.

Some embodiments may comprise transmitting the one or more first authentication process credentials to the bank data processing system prior to the receiving of the authentication-indicative data from the bank data processing system. The first authentication process credential(s) may therefore be used in the first authentication process by the bank data processing system.

Some embodiments may comprise transmitting a request for one or more first authentication process credentials for use in a third authentication process conducted between the user and the bank data processing system. This may provide an additional level of security and reduces the risk of fraud, for example in the form of step-up authentication. For example, the third authentication process may require one or more credentials from the user that are different from one or more of the first authentication process credentials.

Some embodiments may comprise transmitting a request for one or more third authentication process credentials for use in a third authentication process conducted between the user and the bank data processing system in response to determining that a payment authorization request involving the user relates to potentially fraudulent activity. This may provide an additional level of security when needed. In some embodiments, the third authentication process may be conducted only when potentially fraudulent activity is detected; in other words, it may not be routinely requested. This may improve user experience by not requiring the user to conduct the third authentication process unnecessarily.

Some embodiments may comprise receiving one or more third authentication process credentials for use in a third authentication process conducted between the user and the bank data processing system after said receiving of the authentication-indicative data from the bank data processing system. Some embodiments may comprise transmitting the one or more third authentication process credentials for use in the third authentication process after the receiving of the authentication-indicative data from the bank data processing system. The third authentication process credential(s) may therefore be used in the third authentication process by the bank data processing system.

In some embodiments, the one or more first authentication process credentials may be different from one or more second authentication process credentials. This may improve security and reduce the risk of fraud, since one set of credentials being compromised does not necessarily mean that the other set of credentials are compromised. In some embodiments, the one or more user second authentication process credentials may be the same as credentials used to access the services provided by an online merchant. The user may therefore be able to benefit from Single Sign-on (SSO), where they only need to enter the common credentials for the online merchant and for their user account once during checkout.

In some embodiments, the first and/or third authentication process may comprise requesting at least one of: a transaction authentication number (TAN); an indexed TAN (iTAN); a mobile TAN (mTAN); and a chip TAN (ChipTAN). Such embodiments may provide an additional level of security, in the form of TAN-based authentication.

Some embodiments may comprise transmitting a request for updated payment data associated with one or more transactional accounts held by the user with the bank data processing system to the bank data processing system in response to detecting one or more trigger events. As such, further data relating to the user's transactional account(s) may also be stored in association with the user account. For example, the user may set up a new transactional account or get a new payment card and/or one or more details of an existing transactional account or card may change.

Some embodiments may comprise receiving further payment data associated with one or more transactional accounts held by the user with the bank data processing system from the bank data processing system and storing the further payment data in the data store in association with the user account. Such embodiments may improve user experience in that the user does not need to provide such information. This may reduce errors in the data which may occur when entered manually by the user.

In some embodiments, the one or more trigger events may comprise one or more of: receiving a request from the user to determine whether updated payment data is available; expiry of a predetermined time period; determining that payment data stored in association with the user account is no longer valid.

In some embodiments, payment data associated with a plurality of transactional accounts held by the user may be stored in the data store in association with the user account. Such embodiments may comprise transmitting data identifying the plurality of transactional accounts to an online merchant system associated with an online merchant to facilitate selection of a preferred transactional account by the user. Such embodiments may provide the user with more choice in terms of payment options.

Some embodiments may comprise receiving a payment authorization request for a given transaction payment involving the user from an online merchant system associated with an online merchant; retrieving stored payment data for use in the given transaction payment from the data store; and transmitting a payment authorization request comprising at least the retrieved payment data for use in processing the payment authorization request. Some embodiments may comprise transmitting the payment authorization request to a payment processing and settlement system. Some embodiments may comprise receiving a payment authorization response for the given transaction payment. Some embodiments may comprise transmitting a payment authorization response for the given transaction payment to the online merchant system. Such embodiments may make use of the stored payment data for payment authorization processing. In some such embodiments, the payment data may not be communicated to the merchant, which may increase security by virtue of limiting the entities that have access to it.

In some embodiments, settlement of the given transaction payment may be processed as a result of the online merchant system transmitting a payment settlement request separately from the payment authorization request. This allows additional payment possibilities, such as a “goods first” payment, where payment authorization and settlement may be handled separately.

In some embodiments, the payment data may comprise a primary account number (PAN) associated with the user. In some embodiments, the PAN may be associated with a payment card associated with a transactional account held by the user.

In some embodiments, the PAN may be stored on the payment card only in an encrypted format. As such, the user may use the PAN stored on their payment card even though it might not be on the card in human-readable form.

Some embodiments may comprise receiving a request to create the user account. Some embodiments may comprise receiving the request to create the user account from the bank data processing system.

According to a second embodiment, there is provided a system for use in processing payment authorization requests for payment transactions to be conducted via a data communications network, the system comprising a trusted intermediary system configured for: receiving data indicative of the user having been authenticated by a first authentication process conducted between the user and a data communication interface associated with a bank data processing system via a data communication network; activating, in response to the receipt of the authentication-indicative data, a user account corresponding to one or more transactional accounts held by a user at the bank data processing system; storing payment data associated with the one or more transactional accounts in a data store in association with the user account; and retrieving, following a subsequent authentication of the user by a second authentication process conducted between the user and the trusted intermediary system, the stored payment data from the data store for use in processing at least one payment authorization request involving the user.

According to a third embodiment, there is provided a computer program arranged to perform a method for use in processing payment authorization requests for payment transactions to be conducted via a data communications network, the method comprising, at a trusted intermediary system: receiving data indicative of the user having been authenticated by a first authentication process conducted between the user and a data communication interface associated with a bank data processing system via a data communication network; activating, in response to the receipt of the authentication-indicative data, a user account corresponding to one or more transactional accounts held by a user at the bank data processing system; storing payment data associated with the one or more transactional accounts in a data store in association with the user account; and retrieving, following a subsequent authentication of the user by a second authentication process conducted between the user and the trusted intermediary system, the stored payment data from the data store for use in processing at least one payment authorization request involving the user.

According to a fourth embodiment, there is provided a method for use in processing payment authorization requests for payment transactions to be conducted via a data communications network, the method comprising, at a bank data processing system: conducting a first authentication process involving the user and the bank data processing system; and transmitting data, indicative of the user having been authenticated by the first authentication process, to activate a user account for the user in a trusted intermediary system, the trusted intermediary system being arranged to store payment data associated with one or more transactional accounts held by a user at the bank data processing system in a data store in association with the activated user account and to retrieve, following a subsequent authentication of the user by a second authentication process conducted between the user and the trusted intermediary system, the stored payment data from the data store for use in processing at least one payment authorization request involving the user.

In some embodiments, the second authentication process may involve the use of fewer authentication factors than the first authentication process.

Some embodiments may comprise receiving one or more first authentication process credentials for use in the first authentication process.

Some embodiments may comprise receiving the one or more first authentication process credentials via an interface with the trusted intermediary system.

In some embodiments, the interface may use an online banking protocol.

In some embodiments, the protocol may be, or may be based on, the Financial Transaction Services (FinTS) protocol.

Some embodiments may comprise receiving the one or more first authentication process credentials for use in the first authentication process prior to transmitting the authentication-indicative data to the trusted intermediary system.

Some embodiments may comprise transmitting a request for one or more first authentication process credentials for use in a third authentication process conducted between the user and the bank data processing system.

Some embodiments may comprise transmitting the request for the one or more first authentication process credentials for use in the third authentication process conducted between the user and the bank data processing system to the trusted intermediary system.

Some embodiments may comprise transmitting the request for the one or more first authentication process credentials for use in the third authentication process in response to determining that a payment authorization request involving the user relates to potentially fraudulent activity.

Some embodiments may comprise receiving one or more first authentication process credentials for use in a third authentication process conducted between the user and the bank data processing system after transmitting the authentication-indicative data to the trusted intermediary system.

In some embodiments, the first authentication process may be different from the second authentication process.

In some embodiments, the first and/or third authentication process may comprise requesting a transaction authentication number (TAN); an indexed TAN (iTAN); a mobile TAN (mTAN); a chip TAN (ChipTAN).

Some embodiments may comprise transmitting updated payment data associated with one or more transactional accounts held by the user with the bank data processing system from the trusted intermediary system in response to detecting one or more trigger events.

In some embodiments, the one or more trigger events may comprise one or more of: receiving a request from the user to provide updated payment data to the trusted intermediary system; expiry of a predetermined time period; determining that at least some payment data associated with the one or more transactional accounts held by the user with the bank data processing system is no longer valid.

Some embodiments may comprise transmitting the updated payment data dependent on conducting a further authentication process involving the user and the bank data processing system.

In some embodiments, the payment data may comprise a primary account number (PAN) associated with the user.

In some embodiments, the PAN may be associated with a payment card associated with a transactional account held by the user.

In some embodiments, the PAN may be stored on the payment card only in an encrypted format.

According to a fifth embodiment, there is provided a system for use in processing payment authorization requests for payment transactions to be conducted via a data communications network, the method comprising, the system comprising a bank data processing system, the bank data processing system being arranged for: conducting a first authentication process involving the user and the bank data processing system; and transmitting data, indicative of the user having been authenticated by the first authentication process, to activate a user account for the user in a trusted intermediary system, the trusted intermediary system being arranged to store payment data associated with one or more transactional accounts held by a user at the bank data processing system in a data store in association with the activated user account and to retrieve, following a subsequent authentication of the user by a second authentication process conducted between the user and the trusted intermediary system, the stored payment data from the data store for use in processing at least one payment authorization request involving the user.

According to a sixth embodiment, there is provided a computer program being arranged to perform a method for use in processing payment authorization requests for payment transactions to be conducted via a data communications network, the method comprising, at a bank data processing system: conducting a first authentication process involving the user and the bank data processing system; and transmitting data, indicative of the user having been authenticated by the first authentication process, to activate a user account for the user in a trusted intermediary system, the trusted intermediary system being arranged to store payment data associated with one or more transactional accounts held by a user at the bank data processing system in a data store in association with the activated user account and to retrieve, following a subsequent authentication of the user by a second authentication process conducted between the user and the trusted intermediary system, the stored payment data from the data store for use in processing at least one payment authorization request involving the user.

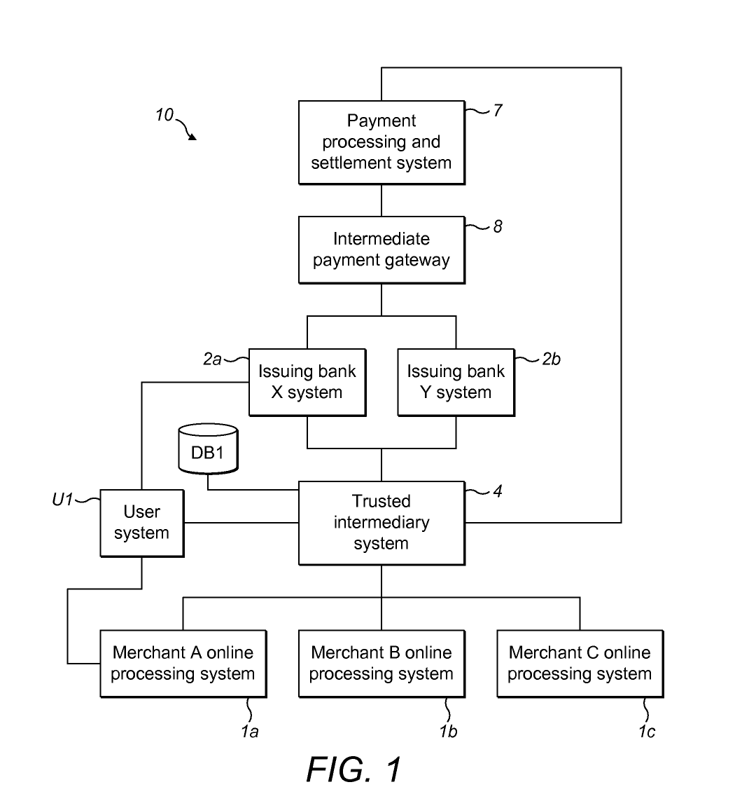

FIG. 1 shows a payment system 10 according to embodiments, in which a user, making use of an online device, referred to as user system U1, holds one or more transactional accounts (e.g. a current account or checking account) with one or more of a plurality of different issuing banks 2a, 2b.

The user system U1 may comprise a personal computer, a tablet computer device, a smartphone, smart TV or other Internet-connected device, for example, equipped with a browser which allows the user to access an online merchant shopping website provided by a merchant online processing system 1a . . . 1c. The user system U1 may be connected via data communications links via which the user is able to enter into a transaction with one of a plurality of online merchant systems 1a, 1b, 1c when purchasing goods over the Internet. The online merchant systems 1a, 1b, 1c may be equipped with website software that enables the user to select a payment method for the purchase of their selected goods. Each merchant online processing system 1a . . . 1c may be modified to include an option to pay using a trusted intermediary system, this identifying a payment request via a trusted intermediary system 4.

The trusted intermediary system 4 may hold data in a database DB1 corresponding to merchants 1a, 1b, 1c and issuing banks 2a, 2b that have registered with the trusted intermediary system 4. The database DB1 may also store data identifying user accounts, referred to herein as “digital wallets” accessible via the trusted intermediary system 4. A digital wallet may stores payment data associated with a user's bank account(s). The payment data may include payment instrument identification data such as a payment card number and/or transactional account details (such as a sort code and account number or an International Bank Account Number (IBAN)). The payment data may include other data, such as billing address(es), payment card expiry date, a card security code (CSC) such as a card verification value (CVV) or the like.

The issuing banks 2a, 2b may include banks that assign an appropriate debit card number to enable payment requests to be routed back to the transactional account holder's current account via a payment processing and settlement system 7 and assume the primary liability for the user's capacity to settle any debts incurred with the debit card number. However, this case of the issuing bank 2a, 2b assigning a debit card number to the user in conjunction with the user's bank account is to be considered a non-limiting example of an application of embodiments, as other payment data may be used in the alternative. A physical debit card may not be necessary, and the issuing bank may not be required to issue a physical card in conjunction with the debit card number or other payment data.

It is to be noted that the payment processing and settlement system 7 may route debit card payments back to the issuing bank that issued the debit card number via one or more intermediate payment gateways 8.

For example, the German payment network includes a number of gateways (“Kopfstellen”) which act as central gateways for processing national debit card transactions that may be made by a user face to face (F2F) with a merchant in Germany. The Kopfstelle may offer routing and switching services for German banks both in terms of issuing and acquiring. Cross-border F2F debit card transactions may also be routed to German banks via the Kopfstelle. It will be appreciated that other countries may have different or no such intermediate payment gateways 8.

Payment Processing Using a Digital Wallet

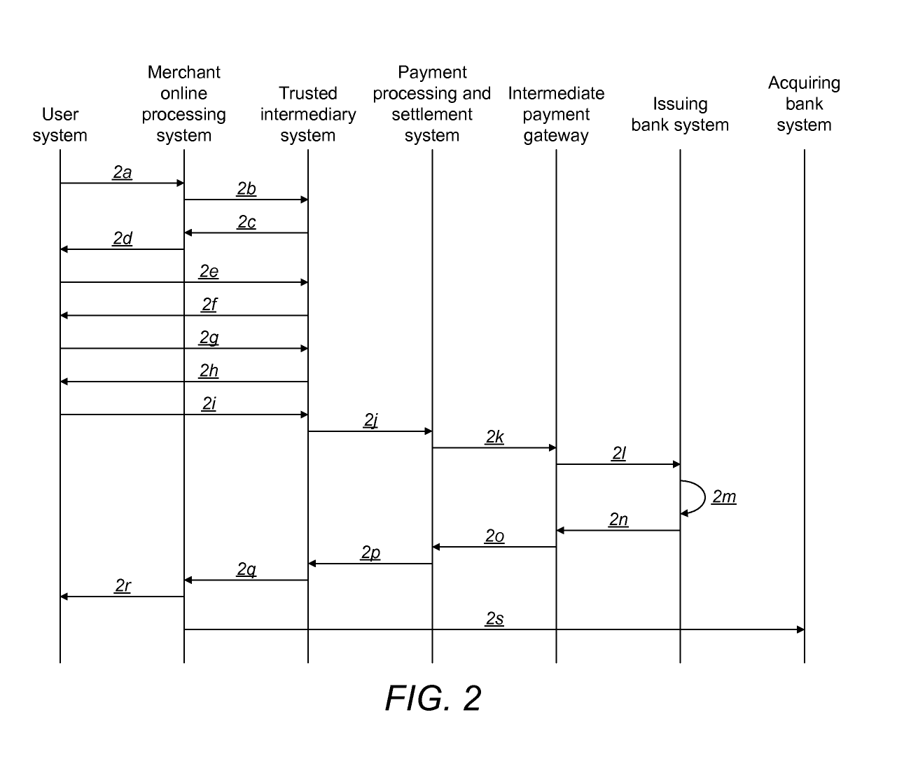

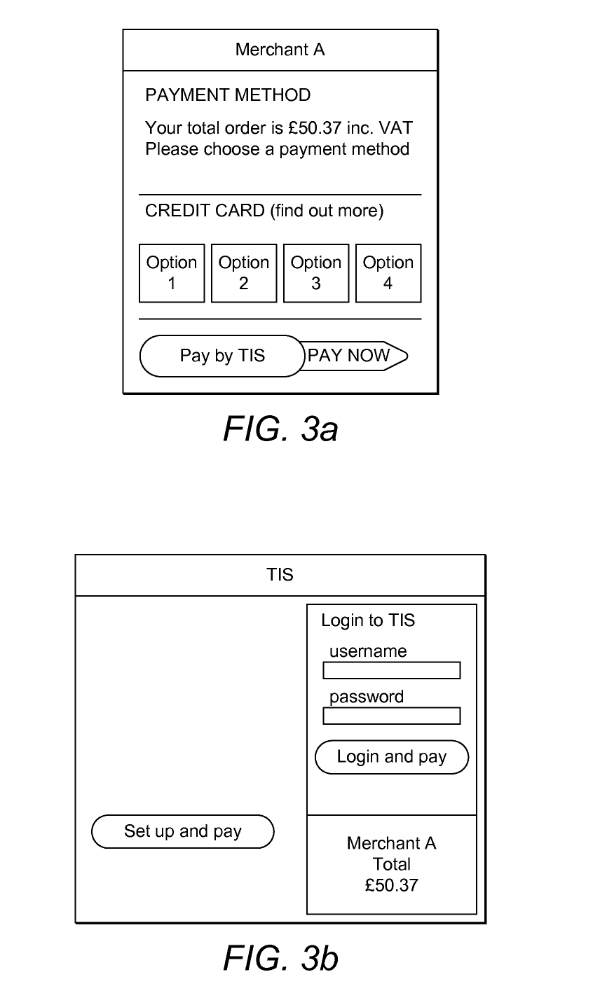

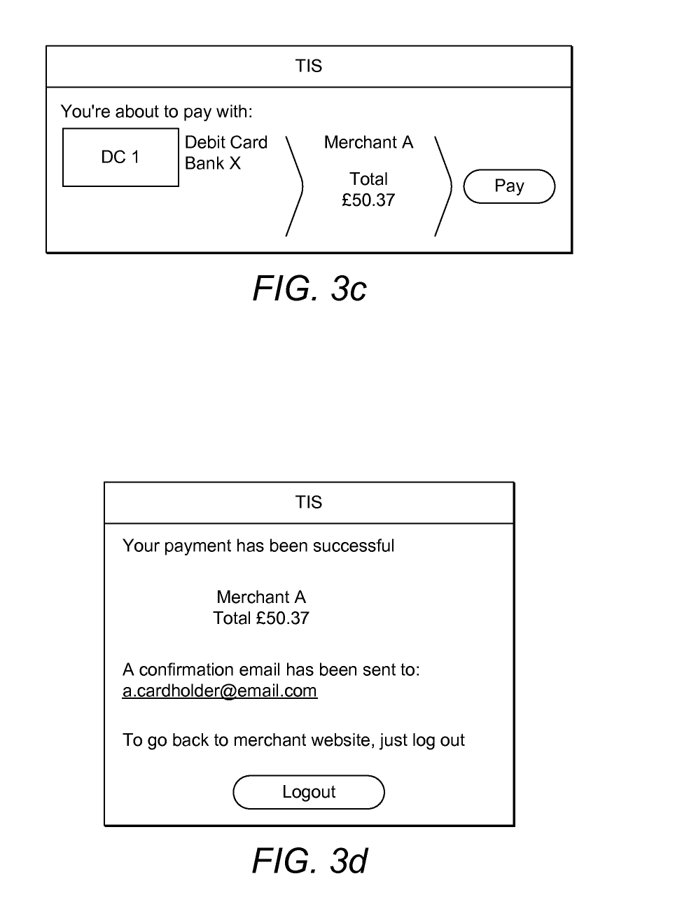

FIGS. 2, 3a, 3b, 3c and 3d illustrate payment authorization request processing in accordance with some embodiments. In the steps described below in relation to FIGS. 2 and 3, the user already has a user account, also referred to herein as a “digital wallet”, held by the trusted intermediary system 4. The digital wallet may include payment data associated with one or more transactional accounts held by the user.

Prior to step 2a, the user has completed their shopping experience with an online merchant using the merchant online processing system, may have initiated checkout to purchase one or more items, and may have proceeded to a virtual checkout, according to conventional methods available through commonly available shopping cart and checkout software packages such as are known to the skilled person.

The online merchant's website may prompt the user to select a payment option for the purchase. This may be displayed to the user in a similar manner to that shown in FIG. 3a. In embodiments, the options may include options to pay by credit or debit card, by entering their card details directly into the merchant website, or to opt for payment using a digital wallet via the trusted intermediary system. Note that in FIG. 3a, and in various ones of the following figures, the trusted intermediary system is referred by the initials “TIS”—so for example, the button labelled “Pay by TIS” corresponds with the option to pay via the trusted intermediary system.

At step 2a, the user may select the option to pay using their digital wallet and the user system U1 transmits a corresponding request to the merchant online processing system 1.

At step 2b, the merchant online processing system 1 may transmit a message to the trusted intermediary system 4 including for example an amount of payment for the one or more items, a merchant account identifier and an identifier for the order.

At step 2c, the trusted intermediary system 4 may transmit to merchant online processing system 1 a Uniform Resource Locator (URL) of a login page for the digital wallet service and the merchant online processing system 1 may, in step 2d, transmit the Uniform Resource Locator (URL) in an iFrame, the content of which may include the digital wallet service login page, which the user system 1 may retrieve from the trusted intermediary system 4 at steps 2e and 2f. The iFrame may be used to embed the login page for the digital wallet service in the online merchant's payment webpage. The login page may be displayed to the user in the iFrame in a similar manner to that shown in FIG. 3b.

At step 2g, after the user enters their digital wallet credentials, for example a username and password, into the login page, the user system U1 may transmit the entered details to the trusted intermediary system 4.

At step 2h, the trusted intermediary system 4 may authenticate the user based on the digital wallet credentials received at step 2g and, following successful authentication, may transmit a payment option selection request to the user system U1. The payment option selection request may include a default payment option identifier and/or a list of payment options (which may be displayed in a similar manner to that shown in FIG. 3c) for which payment data is stored in the user's digital wallet.

At step 2i, after the user has confirmed the default payment option and/or selected a preferred payment option from the displayed list and confirmed they wish to proceed with the payment, the user system U1 may transmit a confirmation message to the trusted intermediary system 4.

At steps 2j, 2k and 2l, the trusted intermediary system 4 may transmit a payment authorization request to the issuing bank system 2 via the payment processing and settlement system 7 and the intermediate payment gateway. The payment authorization request may include payment instrument identification data identifying the default or selected payment option.

At step 2m, issuing bank system 2 may receive and process the payment authorization request. The issuing bank system 2 may generate an authorization code indicating that it has authorized the payment request.

At steps 2n, 2o and 2p, the issuing bank system 2 may transmit a payment authorization response including the authorization code to the trusted intermediary system 4 via the intermediate payment gateway and the payment processing and settlement system.

At step 2q, after receiving the payment authorization response, the trusted intermediary system 4 may transmit an appropriate payment authorization response to the merchant online processing system 1 to inform the online merchant of the result of the payment authorization request.

At step 2r, the merchant online processing system 1 may transmit a payment confirmation page to inform the user of the result of the payment authorization request. A suitable message, which may be similar to the message shown in FIG. 3d, may be displayed to the user in the iFrame to confirm successful payment. The online merchant processing system may, in addition or alternatively, display a confirmation page to the user.

At step 2s, the online merchant processing system may transmit the authorized payment details, including the authorization code, to their acquirer bank for settlement.

Digital Wallet Activation

Embodiments have been described above in which the user has already activated a digital wallet at the trusted intermediary system 4. Embodiments will now be described for activating a digital wallet at the trusted intermediary system 4.

Digital Wallet Activation Via Online Banking Website

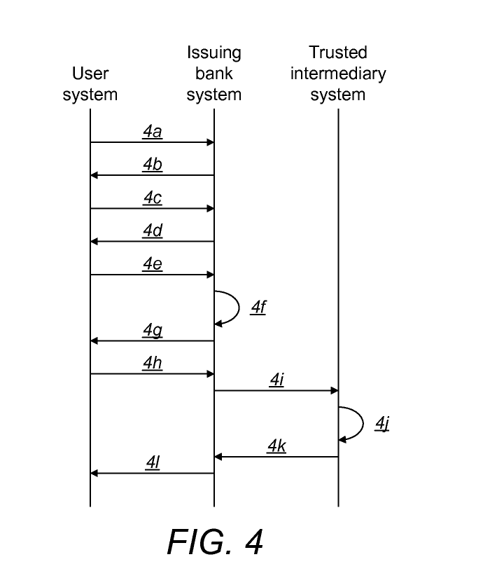

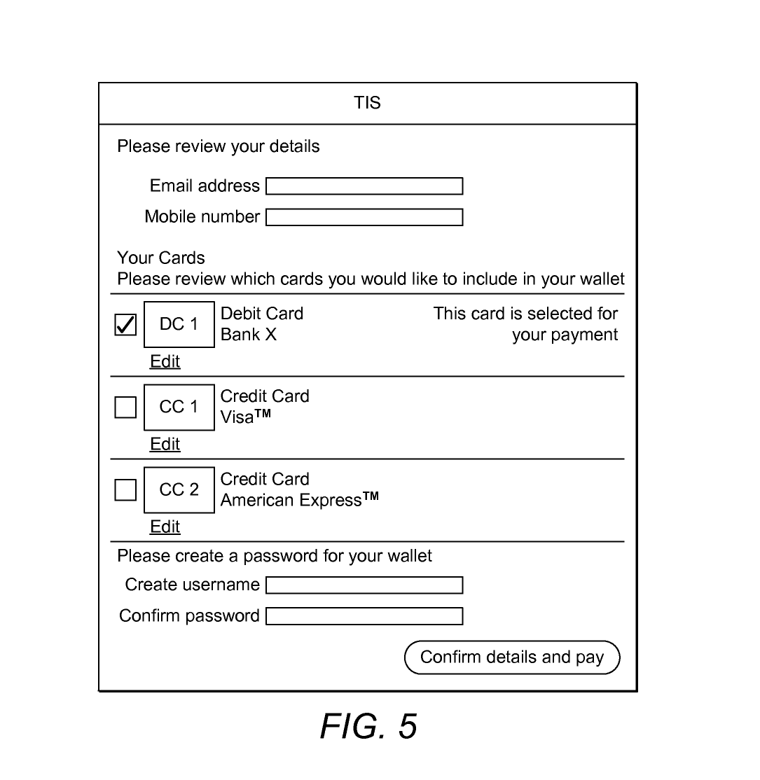

In embodiments depicted in FIGS. 4 and 5, a user activates their digital wallet via their online banking website. In these embodiments, the user may activate the digital wallet before any transaction to pay with the digital wallet is initiated.

At step 4a, the user may enter the URL of the online banking login webpage associated with their online banking service into their browser, or otherwise accesses their online banking login page. Alternatively, the user may use specific application software, such as a smartphone application, to access their online banking system.

At step 4b, the user system U1 may retrieve the online banking login webpage, which prompts the user to enter their online banking credentials, including a username such as a customer number, and one or more of password, memorable personal data, a Personal Identification Number (PIN) or the like.

In some embodiments, the interface between the user system U1 and the issuing bank system 2 may use an online banking protocol. For example, the Financial Transaction Services (FinTS) protocol is an online banking protocol designed for use in online banking in some countries, such as Germany, and was previously known as the Home Banking Computer Interface (HBCI). FinTS may be implemented on top of Hypertext Transfer Protocol (HTTP) or HTTP Secure (HTTPS) as a communication layer. FinTS enables a single client application or software element to communicate with multiple different banks that support its use. A FinTS session involves a session initialization stage which involves mutual authentication, a transaction message exchange stage, and then a session termination stage. Since FinTS may be used over public networks such as the Internet, the standard includes various security measures, such as the use of Data Encryption Standard (DES) and RSA encryption and signatures and the storage of encryption keys on an external physical device (for example a chip card) for improved security. FinTS also supports the use of PINs and TANs for authentication purposes.

At step 4c, the user may enter their online banking credentials into the online banking login webpage and the user system U1 may transmit the entered online banking credentials to the issuing bank system 2.

At step 4d, following successful authentication of the user based on the entered online banking credentials, the issuing bank system 2 may redirect the user to a webpage that may display an option to activate a digital wallet with the trusted intermediary system 4, for example by displaying a button including suitable text.

At step 4e, the user may select the option to activate the digital wallet and the user system U1 transmits a message indicating the user's selection of this option to the issuing bank system 2.

At step 4f, the issuing bank system 2 may retrieve payment data associated with one or more transactional accounts held by the user at the issuing bank. For example, the payment data may comprise payment instrument identification data associated with one or more current accounts and/or one or more payment cards, such as a debit card, held by the user at the issuing bank. In some embodiments, prior to step 4f, the issuing bank may require the user to conduct additional authentication with the issuing bank to authorize activation of the digital wallet. Authentication of a user for activation of their digital wallet may additionally require one or more of the following additional authentication factors:
device-based authentication—data derived from a device the user has possession of (e.g., ID card, security token, software token, phone, or cell phone) and/or data gathered through communication with the user system U1, such as automatic detection of device type, connection or other software or hardware characteristics, or other data derived from communication with the user system U1, e.g. geo-location data derived from the IP address of the user system U1).
biometric authentication—biometric data derived from the user (e.g., fingerprint or retinal pattern, signature or voice recognition, unique bio-electric signals, or another biometric identifier).
other authentication factors—such as a one-time password (OTP) entered by the user.

At step 4g, the issuing bank system 2 may transmit at least some of the retrieved payment data or data associated therewith to the user system U1 for display to the user. The information displayed to the user may represent one or more current accounts, payment cards or other payment instruments for which the issuing bank has retrieved payment data, such as is shown in FIG. 5. In some embodiments, only partial payment data may be displayed to the user; for example, only part of a payment card number (for example, the final four digits) may be displayed to the user.

The user may also be provided with the opportunity to enter additional data associated with activating the digital wallet and/or to confirm activation. The additional data may include, for example, one or more digital wallet credentials to be used to access the digital wallet when activated, contact details such as an e-mail address and mobile telephone number etc.

The user may be provided with an option to enter additional data relating to one or more bank accounts and one/or more payment cards associated with different issuing banks.

At step 4h, the issuing bank system 2 may receive the user's response to the request of step 4g.

At step 4i, the issuing bank system 2 may transmit a digital wallet activation request to the trusted intermediary system 4. The digital wallet activation request may comprise authentication-indicative data including the retrieved payment data and the additional data entered by the user, for example the digital wallet credential(s).

At step 4j, the trusted intermediary system 4 may create and activate a digital wallet for the user and may populate it with the payment data received from the issuing bank system 2 at step 4i. The trusted intermediary system 4 may associate the digital wallet credential(s) with the user's digital wallet.

At step 4k, the issuing bank system 2 may receive a digital wallet activation response from the trusted intermediary system 4, in this case indicating that a digital wallet has been successfully activated for the user.

At step 4l, the issuing bank system 2 may transmit an appropriate confirmation message to the user system U1 for display to the user to confirm that their digital wallet has been successfully activated at the trusted intermediary system 4.

The intermediary system 4 may generate and send an e-mail to an e-mail address associated with the user to confirm successful activation and/or notify the user via an SMS to registered mobile phone and/or send an alert to the user's mobile banking, wallet or payment application on their mobile phone, for example using push notifications.

As such, the user's digital wallet may be pre-populated at activation with payment data from the user's issuing bank. This may reduce the risk of the user erroneously entering incorrect payment data compared to manual entry by the user. This may also reduce the amount of user interaction for adding the payment data to the digital wallet since it may be added automatically by the issuing bank system 2, rather than being entered manually by the user.

In some embodiments, the issuing bank system 2 may record the successful activation of the digital wallet for the user such that it need not display an option to activate a digital wallet with the trusted intermediary system 4 each time the user logs into their online banking service.

In some embodiments, the issuing bank system 2 may transmit payment data associated with one or more transactional accounts held by the user to the trusted intermediary system 4 prior to the user selecting an option to activate their digital wallet. The trusted intermediary system 4 may then store the payment data in the database DB1 and retrieve the payment data associated with the user if and when the user activates their digital wallet. As such, the activation request of step 4i may comprise authentication-indicative data, and may include the additional data, but may not the payment data itself. In some such embodiments, the issuing bank system 2 may transmit a batch of payment data for multiple different users prior to those users activating a digital wallet with the trusted intermediary system 4.

Digital Wallet Activation Via the Trusted Intermediary System 4

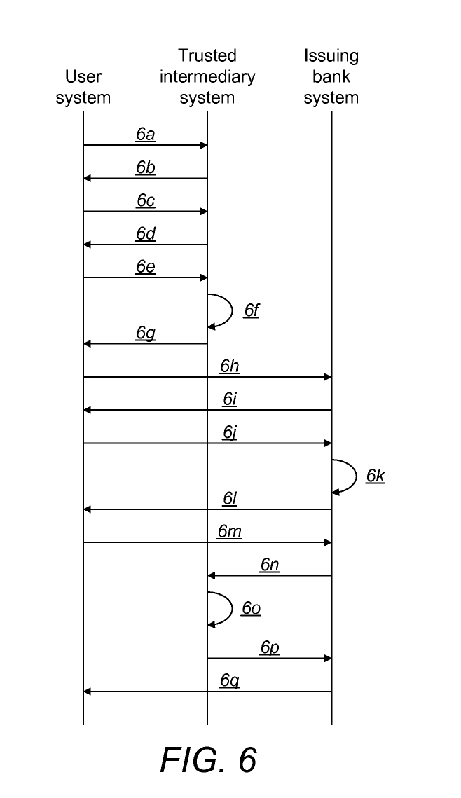

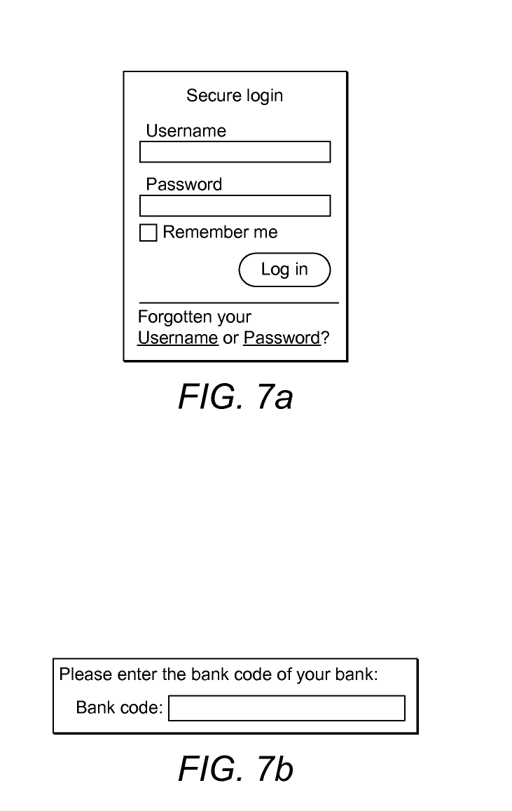

In embodiments depicted in FIGS. 6, 7a and 7b, a user may activate their digital wallet with the trusted intermediary system 4 directly via a digital wallet activation webpage associated with the trusted intermediary system 4. In these embodiments, the user may activate the digital wallet outside a transaction.

At step 6a, the user system U1 may request the digital wallet activation webpage, for example as a result of the user entering the URL of the digital wallet activation webpage or otherwise.

At step 6b, the user system U1 may retrieve the digital wallet activation webpage. The digital wallet activation webpage may provide the user with an option to activate a digital wallet with the trusted intermediary system 4 and may also provide the user with the option to log into their digital wallet service if they already have a digital wallet to manage their account, such as is shown in FIG. 7a.

At step 6c, after the user has selected the option to activate a digital wallet, the user system U1 may transmit a message to the trusted intermediary system 4 indicating that the user has selected the digital wallet activation option.

At step 6d, the trusted intermediary system 4 may prompt the user to enter information identifying the issuing bank they wish to use to activate their digital wallet. The user may be prompted to enter data, for example, in the form of country code and bank name (for example “GB” and “HSBC”) or a code such as Bank Identifier Code (BIC), SWIFT code, a country-local clearing number such as sort code (in the UK) or a Bankleitzahl (in Germany), or a Bank Routing Number (also known as an American Banking Association (ABA) Number), such as is shown in FIG. 7b. Alternatively or additionally, the user may be able to identify the relevant issuing bank in another manner (for example by selecting from a drop-down list of issuing banks that have signed up for the digital wallet service).

At step 6e, after the user has entered the issuing bank identification data, the user system U1 may transmit the entered issuing bank identification data to the trusted intermediary system 4.

At step 6f, the trusted intermediary system 4 may use the issuing bank identification data received at step 6e to identify the relevant issuing bank, for example by performing lookup in a table holding URL details for a range of issuing banks.

At step 6g, the trusted intermediary system 4 may transmit a redirection instruction to the user system U1, causing the browser to be redirected to the online banking login webpage for their issuing bank.

In an Internet-based arrangement this redirection may involve directing the user's browser to a web server associated with the issuing bank. This web server may provide an online banking login page. In some embodiments, redirection may occur under the control of the trusted intermediary system 4, which is to say the online banking login webpage that may be displayed to the user is effectively encapsulated within a web page controlled by, or issued in association with, the trusted intermediary system 4.

Steps 6h to 6q correspond to steps 4c to 4l described above in relation to FIG. 4.

Digital Wallet Activation Via a Merchant Online Processing System

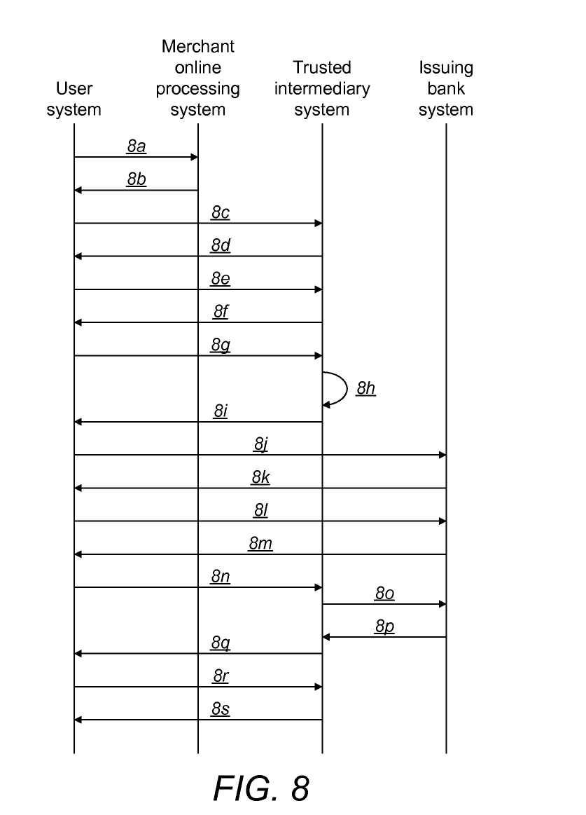

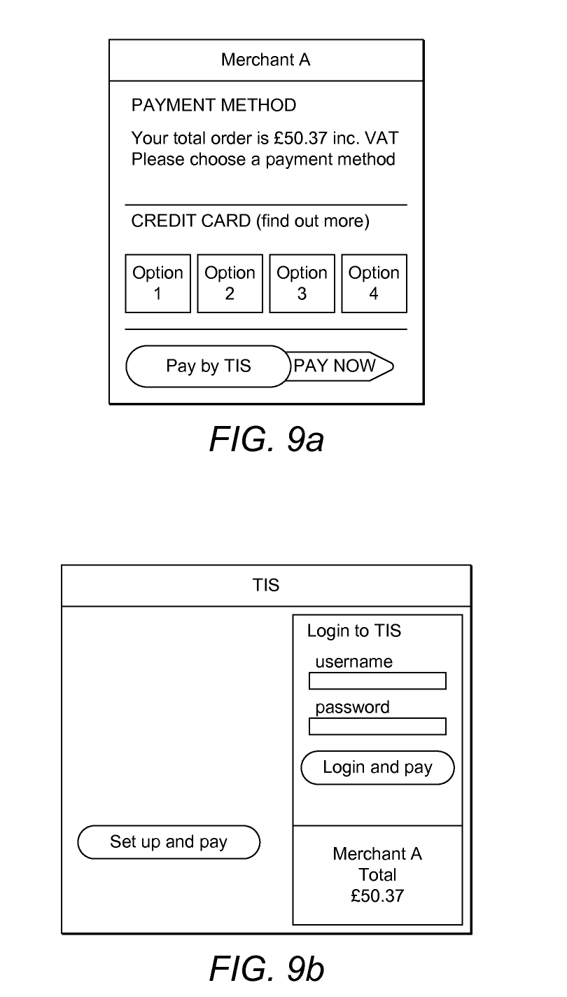

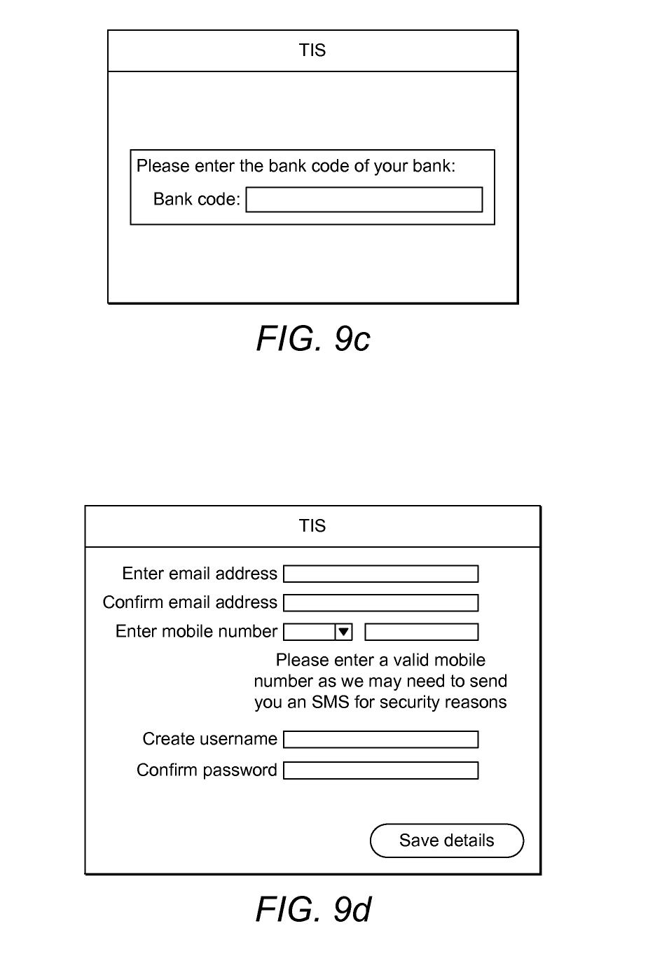

In embodiments depicted in FIGS. 8, 9a, 9b, 9c and 9d, a user may activate their digital wallet during transaction processing via the merchant online processing system 1. Activation may thereby be embedded seamlessly into the user's checkout experience and may use authentication through online banking for activation. In these embodiments, the user may activate the digital wallet in-transaction.

Prior to step 8a, the user may have initiated a transaction via the online merchant, may have selected one or more products and/or services for purchase, and may have initiated a purchase completion process. The user may be prompted to select a payment option for their purchase. The payment options may include paying using a digital wallet, such as is depicted in FIG. 9a.

At step 8a, the user may select the option to pay using a digital wallet, and the user system U1 may transmit a corresponding message to the merchant online processing system 1.

At steps 8b, 8c and 8d, the merchant online processing system 1 may transmit a message to the user system U1 to trigger the browser to reload its payment page within an iFrame, the content of which may be provided by the trusted intermediary system and which may correspond to the content of a digital wallet payment page. The message sent from the user system U1 may include a return merchant URL, which may be passed from the merchant online processing system through the user system U1 to the trusted intermediary system 4 in message 8c, where it may be temporarily stored for use later in the process. The iFrame may provide the user with an option to activate a digital wallet with the trusted intermediary system 4. The content of the iFrame may be such as is shown in FIG. 9b.

At step 8e, after the user may have selected the option to activate a digital wallet, the user system U1 may transmit a message to the trusted intermediary system 4 indicative of the user requesting digital wallet activation.

At step 8f, the trusted intermediary system 4 may prompt the user to enter information identifying the issuing bank they wish to use to activate their digital wallet, as is shown in FIG. 9c.

At step 8g, after the user may have entered the issuing bank identification data, the user system U1 may transmit the entered issuing bank identification data to the trusted intermediary system 4, as per step 6e described above.

At step 8h, the trusted intermediary system 4 may use the issuing bank identification data received at step 8g to identify the relevant issuing bank.

At step 8i, the trusted intermediary system 4 may transmit a redirection instruction for the iFrame including the URL of the user's online banking system website.

At steps 8j and 8k, the user system U1 may request and retrieve the online banking login webpage from a web server associated with the issuing bank system 2.

At step 8l, the user may enter their online banking credentials into the online banking login webpage and the user system U1 may transmit the entered online banking credentials to the issuing bank system 2. In some embodiments, the issuing bank may require the user to conduct additional authentication with the issuing bank to authorize activation of the digital wallet. Authentication of a user for activation of their digital wallet may additionally require one or more of the following additional authentication factors:
device-based authentication—data derived from a device the user has possession of (e.g., ID card, security token, software token, phone, or cell phone) and/or data gathered through communication with the user system U1, such as automatic detection of device type, connection or other software or hardware characteristics, or other data derived from communication with the user system U1, e.g. geo-location data derived from the IP address of the user system U1).
biometric authentication—biometric data derived from the user (e.g., fingerprint or retinal pattern, signature or voice recognition, unique bio-electric signals, or another biometric identifier).
other authentication factors—such as a one-time password (OTP) entered by the user.

Assuming login and/or additional authentication to be successful, the issuing bank system may send an instruction to the user system U1 to redirect the iFrame back to the trusted intermediary system 4, and includes an authentication token.

At step 8n, the redirection instruction may trigger the user system U1 to send a request message to the trusted intermediary system 4 to request payment data for the user from the issuing bank system 2. The request message may include the authentication token, which may be indicative of the user having been authenticated by a previous authentication process conducted between the user and the issuing bank system 2.

At step 8o, the trusted intermediary system 4 may request the payment data from the issuing bank system 2, using the authentication token transmitted to the trusted intermediary system 4.

At step 8p, the issuing bank system 2 may transmit the payment data to the trusted intermediary system 4.

At step 8q, the trusted intermediary system 4 may generate, and load into the iFrame, a verification page for display to the user which may enable the user to verify the retrieved payment data and also to provide the user with an opportunity to enter additional data, such as the newly activated digital wallet credentials, such as is shown in FIG. 9d.

At step 8r, the user system U1 may transmit the user's response to the verification page which may include the additional data.

At step 8s, following successful activation of the digital wallet for the user, the trusted intermediary system 4 may transmit the return merchant URL to the user system U1, together with notification of successful activation, causing the iFrame to empty, reload with JavaScript code from the merchant system, and thus remove the iFrame and return the user to the merchant's website. Finally, the merchant may display the notification that digital wallet activation was successful, and that the transaction may be proceeded with.

Processing may then proceed in a similar manner to steps 2f to 2s described above.

Whilst the foregoing example involves redirecting the user's browser to a web server associated with the issuing bank to allow the user to provide online banking credentials directly to the issuing bank to log onto the online banking service offered by the issuing bank, an interface may be provided to the issuing bank via the trusted intermediary system 4. The user system U1 and the issuing bank may therefore exchange messages via the trusted intermediary system 4, which may act as an agent between the user system U1 and the issuing bank. The trusted intermediary system 4 may act as a FinTS client logically located between the user system U1 and the issuing bank system 2 FinTS server. The user system U1 may communicate with the trusted intermediary system 4 and the FinTS client at the trusted intermediary system 4 may in turn communicate with the issuing bank system 2.

In these embodiments, the issuing bank system 2 may activate the authentication token and the trusted intermediary system 4 may use the token to request the payment data. In other embodiments, the issuing bank system 2 may transmit the payment data to the trusted intermediary system 4 following positive authentication of the user via the online banking website at step 8l.

Payment Instrument Identification Data

Payment instrument identification data may be used to identify payment instruments in the payment system 10. Various different payment instrument identification data formats or types may be used in the payment system 10.

For example, a payment instrument identifier may be an International Bank Account Number (IBAN) for identifying a bank account, a payment card number for identifying a given payment card, a bank sort code and bank account number and the like.

In some cases, the issuing bank may make the user aware of the payment instrument identification data, for example by embossing the payment instrument identification data on a payment card, including the payment instrument identification data on a bank statement and/or in other communications with the user. This enables the user to make payments using the associated payment instrument. For example, a user may be aware of their IBAN, payment card number and their bank sort code and bank account number. The user may also be aware of related payment data, such as the CVV number embossed on their payment card and a card's expiry date which may also be embossed on a payment card. The user may therefore be able to enter such payment data manually into their digital wallet and/or provide such details to a merchant. Alternatively, in accordance with embodiments, the issuing bank system 2 may provide such payment data to the trusted intermediary system 4 for storage in the user's digital wallet.

In some cases, a payment instrument may be associated with a payment instrument identifier which it may not be desired to disclose to the user (or, for example, an online merchant with which the user conducts online shopping) or may otherwise not be (readily) available to the user for manual entry into the digital wallet.

Primary Account Number (PAN)

Another form of payment instrument identifier may be a PAN. A PAN may be used to identify an issuing bank and account held by a user at the issuing bank. PANs may take various different forms. For example, in Germany a PAN may be a 19-digit number having the following parts, in the following order:
a three-digit Bank Identification Number (BIN);
a one-digit number selected from (0, 1, 2, 5, 6 & 9), which may be used to identify a particular Kopfstelle or bank association;
a four-digit bank code, which may be mapped into a longer-form bank sort code;
a ten-digit account number; and
a one-digit check digit.

The PAN may be stored on the magnetic stripe and/or computer chip embedded in a corresponding debit card when the card is created and, in some cases, may not be embossed on the surface of the debit card itself. In such cases, the PAN may not be visible to the user in human-readable form on the debit card itself and the user may even be unaware of the existence of the PAN stored on the debit card.

Since the user may be unable to determine the PAN, which may be used by the issuing bank system 2 to identify the user's bank account, the user may be unable to provide the PAN to an online merchant for use in online payments.

However, in some embodiments, the trusted intermediary system 4 may retrieve the PAN from the issuing bank system 2 for storage in the user's digital wallet. Thus, the user may make online payments using the debit card using their digital wallet since the PAN may be stored in the user's digital wallet.

As explained above, it may be desired not to disclose the PAN to the user (or, for example, an online merchant with which the user conducts online shopping). However, it may be desirable to represent the debit card with which the PAN is associated to the user, for example to allow the user to select it as a payment option when shopping online. In some embodiments, instead of representing the debit card using the PAN, the trusted intermediary system 4 may use different data to represent the debit card.

For example, the trusted intermediary system 4 may represent the debit card using a graphical representation of the debit card (which may allow the user to distinguish it from their other payment cards), all or part (for example the final four digits) of a payment card number may be embossed on the debit card and/or a user-friendly description of the debit card. The trusted intermediary system 4 may retrieve some or all of this data from the issuing bank system 2, for example when the user activates the digital wallet, and/or from the user.

Thus, in some embodiments, the payment instrument identifier used to identify the payment instrument to the user may be different from the payment instrument identifier used by the issuing bank system 2 to process transaction authorization requests associated with the payment instrument. As such, the user may be able to identify the payment instrument and the PAN associated with the payment instrument need not be shared with the user.

Generating Payment Instrument Identification Data

Embodiments will now be described which relate to generating payment instrument identification data. Although, these embodiments relate specifically to generating a PAN, generation of payment instrument identification data in different forms is envisaged.

In some embodiments, the issuing bank system 2 generates a PAN when issuing a payment card. The PAN may be generated according to pre-defined rules and may be derived from, for example, the user's bank account number, the BIN etc. and may also include a check digit. The issuing bank system 2 may provide the PAN to the trusted intermediary system 4 for storage in the user's digital wallet. This allows the user to use the payment card for transactions conducted via the trusted intermediary system 4 and the payment processing and settlement system 7.

In some embodiments, the issuing bank system 2 may be able to generate a PAN independently of issuing a payment card. For example, the issuing bank system 2 may generate a new PAN (referred to herein as a ‘virtual PAN’) to be associated with a payment card or a bank account. The issuing bank system 2 may generate virtual PANs according to the same, pre-defined rules used when generating a PAN at the same time as issuing a payment card.

The issuing bank system 2 may generate a virtual PAN for a payment card that may not already be associated with a PAN to enable transactions involving the payment card to be processed via the trusted intermediary system 4 and the payment processing and settlement system 7. However, the issuing bank system 2 may generate a virtual PAN for a payment card even if the payment card is already associated with a PAN. The virtual PAN may be used to allow, for example, different payment limits for payments based on the virtual PAN compared to payments based on the existing PAN. Furthermore, the association of the virtual PAN with the payment card may be maintained even if the payment card was reissued and the reissued card was associated with a new PAN.

In some embodiments, the trusted intermediary system 4 may be able to generate a virtual PAN. For example, the user may provide an IBAN associated with their bank account to the trusted intermediary system 4 and the trusted intermediary system 4 may generate a corresponding virtual PAN using the pre-defined PAN generation rules. The trusted intermediary system 4 may identify the relevant issuing bank 2—the issuing bank being identifiable from the IBAN—and may send the generated virtual PAN to the relevant issuing bank 2. The relevant issuing bank 2 may store the virtual PAN generated by the trusted intermediary system 4 in association with the user's bank account such that it may map payment authorization requests including the virtual PAN to the user's bank account and stores the virtual PAN in the user's digital wallet.

Interaction Between the Issuing Bank and the Trusted Intermediary System 4 Following Digital Wallet Activation

As explained above, the issuing bank system 2 may provide payment data associated with one or more transactional accounts held by the user to the trusted intermediary system 4 for storage in the user's digital wallet, for example when the digital wallet is activated and/or prior to activation.

In some embodiments, the issuing bank system 2 and the trusted intermediary system 4 may interact further following digital wallet activation.

In some embodiments, the issuing bank may send updated payment data to the trusted intermediary system 4.

The issuing bank system 2 may periodically transmit batch updates to the trusted intermediary system 4 which include any updated payment data associated with payment data that has already been provided to the trusted intermediary system 4. Such batch updates may be for multiple (for example all) users who hold accounts with the issuing bank and who have activated a digital wallet with the trusted intermediate system 4.

The issuing bank system 2 may proactively transmit updated payment data in response to determining that the payment data has been updated. For example, the issuing bank system 2 may transmit updated payment data relating to a replacement payment card so that the trusted intermediary system 4 may replace existing payment data associated with the payment card with the updated payment data.

As explained above, the payment instrument identification data displayed by the trusted intermediary system 4 to the user to represent a given payment option may be different from the payment instrument identification data that the trusted intermediary system 4 transmits to the payment processing and settlement system 7 for processing a payment authorization request.

In some embodiments, the issuing bank system 2 may transmit updated payment data corresponding to the payment instrument identification data displayed to the user even if the payment instrument identification data transmitted to the payment processing and settlement system 7 has not been updated. In some embodiments, the issuing bank system 2 may transmit updated payment instrument identification data for transmission to the payment processing and settlement system 7 even if the payment instrument identification data displayed to the user has not been updated.

In some embodiments, the trusted intermediary system 4 may proactively request updated payment data from the issuing bank system 2. For example, the trusted intermediary system 4 may intermittently check the expiry date of a payment card and request updated payment data corresponding to that payment card if the trusted intermediary system 4 determines that payment card to have expired.

In some embodiments, the trusted intermediary system 4 may provide the user with an option to check whether updated payment data is available at the issuing bank and/or to confirm that updated payment data may be retrieved where the trusted intermediary system 4 has determined that updated payment data is or may be available at the issuing bank system 2.

Express Payment

The trusted intermediary system 4 may provide a payment option where the user may request express payment processing. To register for express payment processing, the user may be required to perform additional authentication and to select or provide details of a default payment method and delivery address. The default payment method and delivery address may be used whenever the user selects the express payment option. Payment may be deferred by, for example, thirty minutes from when the user selects the option to pay using express processing to allow the user to add additional items to their shopping basket, to change their order, or to delete their order. The merchant website may provide a Single Sign-on (SSO) option whereby the user may use their digital wallet account credentials to log into their online shopping account with the merchant, so that the user does not need first to log into their online shopping account and then into the digital wallet service to make an express payment.

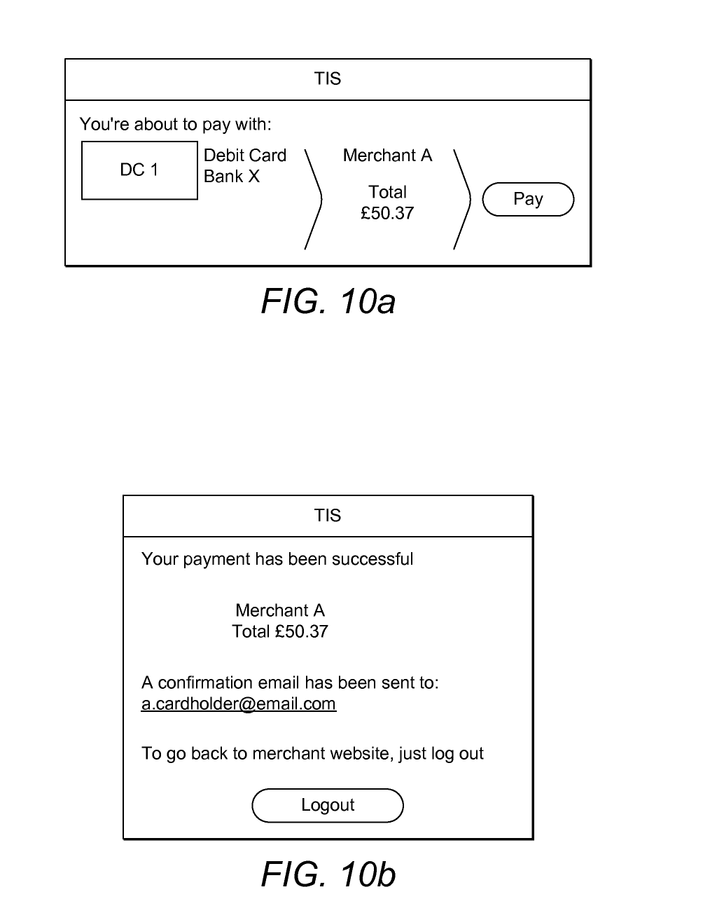

FIGS. 10a and 10b show respectively examples of screens that may be displayed to the user to indicate that express payment is available and to confirm payment. Other screens may also be displayed to inform the user that they have the opportunity to add more items to their shopping cart and/or change their order.

Step-Up Authentication

Embodiments have been described above in which the user is authenticated by their issuing bank 2 using their online banking credentials and possibly using additional layers of security to allow activation of their digital wallet account with the trusted intermediary system 4. The user may also be authenticated by the trusted intermediary system 4 using their digital wallet service credentials to log into the digital wallet service after their digital wallet has been activated.

In some cases, it may be deemed necessary to perform additional, step-up authentication, for example for transactions that may be deemed to be high risk. One or more of the following authentication techniques (or similar techniques) may be available for providing the step-up authentication:
mTAN or CardTAN (described in more detail below).
Callback, where a call is placed to telephone number stored in association with the user's account to verify that the user is performing the payment request. The user may be required to speak to a human operator to confirm their identity, may be required to input a code using their keypad during the call, may hear a code during the call that they then have to enter into an authentication screen displayed on the user system U1 or such like.
VISA CodeSure, where a keypad is embedded into a user's payment card. To perform VISA CodeSure authentication, the user selects an appropriate option on the keypad, enters a PIN and a one-time password is displayed on a display screen on the card. The user then enters the displayed one-time password at an appropriate prompt which may be used to authenticate the user.
Verified by Visa (VbV). A user signs up for VbV and provides a secret personal message and associates a password with their VbV account. During the VbV authentication process, the user may be prompted to enter their VbV password (for authentication purposes) and the personal message may also be displayed to the user so that the user may be assured that the verification request screen is genuine.
Another form of OTP-based authentication.
Challenge/Response.
Mutual authentication.
Successful login to the online banking service.

Goods First Payment Option

In embodiments, communications associated with the authorization, clearing and settlement part of the process may be effected by either single or dual message implementations. The implementation used may be based on the issuer, the type of payment card being used, and the region in which the transaction takes place and/or may be selected by the user in some cases.

In a single message implementation, the merchant's acquiring bank may submit to payment processing and settlement system 7, a single message comprising authorization, clearing and settling data for authorizing, clearing and settling a given transaction such that funds may be moved from the user's issuing bank to the merchant's acquiring bank.

In a dual message implementation, the merchant's acquiring bank may submit to the payment processing and settlement system 7 a first message at the time of purchase which comprises authorization data for authorizing a given transaction and then a second message at a later stage which comprises clearing and settling data for clearing and settling the given transaction.

The dual message implementation may be used to provide a “goods first” option to consumers which is directed towards a deferred payment model, which is currently popular in certain countries such as Germany. The payment may be authorized by the issuing bank at the checkout stage and clearing and settlement may take place at a later stage, for example after the merchant has shipped the purchased goods or later. This enables consumers to have an invoice- or current account-like payment experience where the merchant offers an invoice-type payment at the shipping stage. There is also no risk to the merchant in terms of receiving payment as the payment has already been authorized and reserved for the merchant for a predetermined time frame at the checkout stage.

The goods first option allows for a single capturing process, which may be beneficial where the amount due to the merchant changes after the purchase is initially made. For example, the customer may confirm an order and may change their order shortly after their initial order—delayed capture would allow the amount corresponding to the changed order to be captured. The goods order by the user may be defective or out of stock or may be lost or stolen during shipping—delayed capture may be used to capture an appropriate payment amount. The user may return some or all purchased products and so a partial or full refund would be due to the user—by deferring capture, the actual amount captured (if any) may be changed accordingly.

Configuration of the Trusted Intermediary System 4

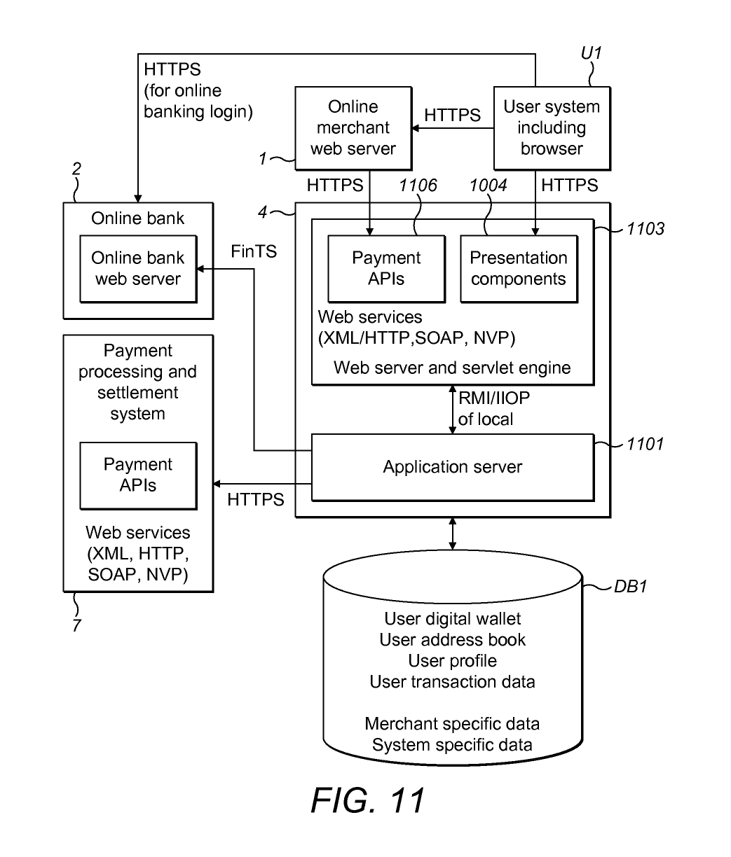

Details of the configuration and processing capabilities of the trusted intermediary system 4 will now be described with reference to FIG. 11.

The trusted intermediary system 4 may be embodied as a web application server, for example as an application server 1101 which manages and provides access to the common business logic of the trusted intermediary system 4, and a web server and servlet engine 1103, which acts as the entry point for external HTTP requests to the trusted intermediary system 4 from merchants and from users' browsers.

The web server and servlet engine 1103 comprises presentation components 1104 which expose secure web services-based payment APIs or API wrappers 1106 to merchant systems and which may be configured to generate and manage the interface to the user system U1, for example when the user wishes to register or selects a payment method in the manner described above.

The trusted intermediary system 4 may comprise various other processing components, which may be configured to transmit and manage various bank-, user- and merchant-specific data, and will now be described.

Digital Wallet Activation Components and Data

When the user wishes to make use of the digital wallet facility offered by the trusted intermediary system 4, they may complete a digital wallet activation process. Activation of the digital wallet held by the trusted intermediary system 4 may be performed via any suitable interface. When the trusted intermediary system 4 is implemented as a web server, activation may be via a web browser. Once registered, each user has an associated profile, which may store demographic and identification data for the user as well as payment data and may be modified via presentation components 1104, while user transaction data and retrieved payment data may be displayed for review by the user. In addition, the user may have address book entries, which hold shipping details. The presentation components 1104 may enable the user to modify the shipping details. Where the trusted intermediary system 4 is implemented as a web server, the presentation components 1104 may interoperate with the user's browser to allow selection and modification of the payment data and possibly other user data as described above. The presentation components 1104 may also enable the user to select and add to/remove from/edit a list of payment instruments stored in the user's digital wallet.

User Authentication Components

Authentication of a user for using their digital wallet may be performed directly with the trusted intermediary system 4 using, for example, 1-factor authentication—data the user knows (e.g., a username and password, pass phrase, or personal identification number (PIN)).

Bank Data Store

The trusted intermediary system 4 may store bank identifiers, for example in the form of Bank Identification Codes (BICs), or country, branch and bank names, for those issuing banks that have signed up to the digital wallet service. For each listed issuing bank, the database DB1 may hold data identifying a URL corresponding to their online banking login page.

Application Programming Interfaces (API) Services Adaptor

The trusted intermediary system 4 may comprise an API services adaptor, which enables connectivity between the trusted intermediary system 4 and the messaging infrastructure of the payment system 10. The adaptor may be configured to manage the fulfillment of the trusted intermediary system 4 requests to external services, such as payment authorizations to the payment processing and settlement system 7 and to expose a set of trusted intermediary system 4 services that may be used by external functions such as the payment processing and settlement system 7.

Transaction-Specific Components and Data

The trusted intermediary system 4 may store transactional data such as payment authorizations and settlements that may be managed by the trusted intermediary system 4. In addition, the trusted intermediary system 4 may store audit data associated with merchant online activity as well as general system activity.

Messaging Services

The trusted intermediary system 4 may be configured with email agents, which compose and transmit emails for the purposes of email address authentication and user activation and purchase order confirmations. The trusted intermediary system 4 may also be configured with an SMS gateway or other PUSH service interfaces for notifications (for example to an Apple Push Notification Services (APNS) server).

Embodiments described above may enable the user to select a payment method on a per transaction basis, whilst removing the requirement for the user to provide payment details to individual merchants. Thus, provided merchants subscribe to the trusted intermediary system 4, users may only need to allow retrieval of, or submit, their respective payment details once, to a single entity. This has the benefit of reducing the risk of fraud that may be incurred in relation to conventional payment systems that require the user to enter their card payment details via the merchant's system.

The above embodiments are to be understood as illustrative examples only. Further embodiments are envisaged.

In some embodiments, one or more additional automated security checks may be used prior to and/or to supplement the authentication of the user by the issuing bank and/or the trusted intermediary system 4. For example, one or more additional automated security checks may be used, including device ID and/or device reputation in relation to the user system U1 via which the user authenticates themselves. In some embodiments, the issuing bank system 2 and/or trusted intermediary system 4 may record a trust level value associated with the authentication performed. The trust level value could be increased or decreased in view of the results of the additional security checks to indicate the level of trust and may lead to different levels of transactions and services being available to the user.

In some embodiments, the user may be first authenticated by the trusted intermediary system 4 and delegate the responsibility to the trusted intermediary system 4 to effect login into the user's selected online bank account. Login may be performed on the basis of a suitable set of credentials supplied by the user, such as a credit card number and/or expiry date, which the user could enter in real time or select from their stored card details, and which forms the basis of authentication of the user by the selected issuing bank.

Whilst in the above embodiments, a transactional account identity may be given in the form of a PAN, other transactional account identities may be used in the alternative. For example, a user's IBAN, or alternatively a bank identifier, which may be an international bank identifier such as country code and sort code, or BIC code, and an account number.

Whilst in the above embodiments, a PAN permanently associated with a user's transactional account may be used, in the alternative, or in addition, an issuing bank system 2 may provide, as account identifier responses, one-time-use PANs which may be generated for one-time use, and a large number of such one-time-use PAN's may be stored and mapped by the issuing bank system 2 against a single transactional account.

Whilst embodiments may make use of iFrame web technology to navigate the user to different web sites, it will be appreciated that standard web redirection may instead be employed. In such alternative arrangements the user's browser may be navigated away from and back to the trusted intermediary system 4 web site, depending on the entity (or rather the URL corresponding thereto) with which the user's browser is communicating at any point in time. For example, when the user's account is activated, the user's browser may be redirected by the digital wallet website to a website provided by, or on behalf of, the user's issuing bank, and once the user authentication and/or account selection is completed, the user's browser may be redirected by the issuer bank website back to the digital wallet website. Other mechanisms are envisaged, such as Asynchronous JavaScript and XML (AJAX) for dynamically loading data into a webpage.

In the foregoing, the term “system”, when applied to entities such as the merchant online processing system 1, the payment process and settlement system 7, the trusted intermediary system 4, the issuing bank system 2 and other entities, should be understood to mean a data processing function, provided at one or more physical sites, connected to other data processing functions via data communications links. Each function may be provided by a single data processing node, for example a server computer, or a set of data processing nodes providing fail-over backup to each other, such as a cluster of server computers, and/or a set of interconnected data processing nodes providing different modular subfunctions with respect to other members of the set, for example an interworking set of different server computers.

As will be appreciated from the foregoing, communications between the various entities comprising the payment system 10 proceed via a data communications network such as the Internet. Each of the entities of the payment system 10 (the issuing bank system 2; the trusted intermediary system 4; the payment processing and settlement system; and the online merchant systems) may be identifiable via a network identifier such as an Internet Protocol (IP) address or other suitable identifier. Suitable data security protocols may be used in relation to the connections between the various entities in the payment system 10, for example Secure Sockets Layer (SSL), encrypted web services and the like.

Accordingly the communications network may comprise a fixed line network comprising one or more technologies i.e. a hybrid communication network; for example the network may comprise the Internet in conjunction with the Public Switched Telephone Network (PSTN) and/or a mobile communication network capable of supporting, for example, one or more of the following communication protocols: GSM (Global System Mobile), WCDMA (Wideband Code Division Multiple Access), GPRS (General Packet Radio Service), Long Term Evolution (LTE/4G). In addition to or instead of the mobile communication network, a local area network such as a Wireless Local area network (WLAN) or BlueTooth® (BT) and/or other technologies such as WiMax may be used to carry part of the request and response messages. In this way, users may interact with the online merchant systems using portable, remote devices. The data communications network may be arranged to support generic Internet access using any transport methods. In addition, or as an alternative, to sending confirmation messages as email messages, payment confirmation messages may be transferred as SMS-messages (Short Message Service), MMS-messages (Multi Media Service), Wireless Application Protocol (WAP) pages, Internet pages, HTML (Hypertext Mark-up Language) pages, XHTML (eXtended HTML) pages, IP-datagrams (Internet Protocol), or push notifications.

One of the embodiments described above relates to a bank account that has a card associated therewith; others do not require the bank account to be associated with a payment product of any type, while others still may involve a bank account associated with a payment product such as a mobile phone or biometric information. Other applications are envisaged.

Embodiments are described above in which a user activates an account for the digital wallet service provided by the trusted intermediary system 4 via their online banking portal, via a merchant website at checkout stage or via a portal to the trusted intermediary system 4 itself. Additional channels for activating the digital wallet account are envisaged.

The user may be prompted to activate and register a digital wallet account after checkout if they have paid by card. For example, the user may be provided with an option on a payment confirmation page to store the just-used card details in a digital wallet account so that they may experience a digital wallet-type checkout experience next time they make an appropriate purchase online.

The user may be prompted to activate and register a digital wallet account after checkout if they have paid by direct debit. For example, the user may be provided with an option on a payment confirmation page to store the just-used current account details in a digital wallet account so that they could experience a digital wallet-type checkout experience next time they make an appropriate purchase online. However, the user may be concerned about having their back account details transmitted to trusted intermediary system 4 without yet having established a trust relationship with the trusted intermediary system 4.

Whilst some embodiments described herein refer to FinTS, it should be understood that this as used herein is intended to include future protocols which are based at least part on the FinTS protocol and/or which provide similar function thereto.

In some embodiments, described above, the user may access their online banking login webpage by entering its URL into a browser, the user may access their online banking login webpage differently. For example, the user may have received an e-mail from their bank indicating that the digital wallet service is available for activation and providing a link to URL of the online banking login webpage. In another example, the user may see an advertisement for the digital wallet service on a website, such as the website of the issuing bank system 2. By clicking on the advertisement, the user's browser may be redirected to the URL of the online banking login webpage.

In some embodiments described above, the user may request creation of the account with the trusted intermediary system 4 when they are provided with an opportunity to select a payment method for goods that they wish to purchase from the merchant. It will be appreciated, however, that the user may be able to request creation of the account with the trusted intermediary system 4 via the merchant website even if they do not wish to purchase any goods from the merchant.

In some embodiments, online banking authentication may require the user to provide an expected Transaction Authentication Number (TAN) for authentication. A TAN may serve as a temporary, single-use password which supplements the authorization performed by the issuing bank when the user logged into their online banking account and thus provides two-factor authentication.

The TAN may be printed on a physical document that includes a list of TANs and the issuing bank keeps a record of the TANs on the list provided to the user. The user may be prompted to enter any TAN in the list. If the user correctly enters one of the TANs on the list, the issuing bank system 2 authenticates the user's activation request. In some cases, the user may be prompted to enter a TAN from the list that has not been used in previous authentication processes with the issuing bank system 2. In other words, once a TAN is used, it may be disregarded by the issuing bank system 2 for further authentication involving the user.

The TAN may be printed on a physical document that includes a list of TANs and corresponding indices or sequence numbers—this may sometimes be referred to as an Indexed TAN (iTAN). The list may be unique to the particular user and, if so, the issuing back 2b records the particular list of TANs provided to the user. The issuing bank system 2 may prompt the user to enter the value of a given TAN in the list (e.g. the fourth TAN in the list). The issuing bank system 2 may check against a corresponding copy of the list of TANs to determine the result of this second layer of authentication.

Instead of the TAN being printed on a physical document, the TAN may be generated on a security token that generates TANs when required. The TAN may be generated using a secret that is known to the issuing bank system 2 and that may be available to the security token and additional input data (such as the time of day or data that may be input by the user). The user may generate a TAN using the additional input data and the security token which may displays the TAN to the user so that the user may enter the generated TAN in the prompt provided by the issuing bank system 2. The issuing bank system 2 may generate an expected TAN which it compared against the received TAN to determine the result of this second layer of authentication.

Mobile TAN (mTAN) may provide another possibility for enabling the user to enter an expected TAN to confirm their activation request. In this case, the issuing bank system 2 may generate a TAN and sends a message such as a Short Messaging Service (SMS) to the user's mobile telephone which includes the generated TAN. The user may enter the received TAN into the prompt provided by the issuing bank system 2 and the entered TAN may be communicated to the issuing bank system 2.

ChipTAN may also be used to generate the TAN. This may involve inserting a bank card associated the user's bank account into a TAN generator. A TAN may then be generated based on data stored on the bank card and may be displayed to the user so that the user may enter it into the prompt provided by the issuing bank system 2.

In addition, rather than using a transaction authentication number (TAN), an indexed TAN (iTAN), a mobile TAN (mTAN) or a chip TAN (ChipTAN), other dynamic authentication methods may be used (one-time passcode, challenge-response etc.)

In embodiments described above, the authentication mechanisms may be used for payment transactions involving merchants, it is also envisaged that issuing bank-based authentication mechanisms may be used when a user wishes to use their digital wallet, provided by the trusted intermediary system, to initiate a person-to-person payment, and may also be used when the user wishes to change certain predetermined profile contact details relating to the user account at the trusted intermediary system, including for example the registered email address and/or the registered mobile phone number used for step-up authentication.

In the embodiments described above, the registration requirements and authentication strength or process may be altered depending on information available to the trusted intermediary system about the user, the user's device, the browser used by the user and the connection used by the user (e.g. the user's IP address) to ensure that risk of fraudulent activity may be reduced. Thus, in addition to the above processes, supplemental additional risk assessment based on automatically collated data about device, user, connection or browser may be employed by the trusted intermediary system 4 to make a decision on increasing or decreasing the registration data requirements or the strength of authentication.

It will be understood that the apparatus and systems described herein may comprise at least one processor or processing system and at least one memory. The memory may comprise computer program code. Accordingly, within the apparatus and/or system, the at least one memory and the computer program code may be configured to, with the at least one processor, cause the apparatus and/or system to perform some or all of the steps describe above.

Moreover, although at least some aspects of the embodiments described herein with reference to the drawings comprise apparatuses or systems performing certain steps, the invention also extends to computer programs arranged to perform some or all of the steps above. These computer programs may be in the form of a non-transitory computer-readable storage medium comprising a set of computer-readable instructions stored thereon, which, when executed by a processing system, cause the processing system to perform some or all of the steps describe above.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the accompanying claims.

What is claimed is:

1. A method for use in processing payment authorization requests for payment transactions to be conducted via a data communications network, the method comprising, at a trusted intermediary system:
receiving data indicative of a user having been authenticated by a first authentication process conducted between the user and a data communication interface associated with a bank data processing system via a data communication network;
activating, in response to the receipt of the authentication-indicative data, a user account corresponding to one or more transactional accounts held by the user at the bank data processing system;
storing payment data associated with the one or more transactional accounts in a data store in association with the user account; and
retrieving, following a subsequent authentication of the user by a second authentication process conducted between the user and the trusted intermediary system, the stored payment data from the data store for use in processing at least one payment authorization request involving the user.

2. The method of claim 1, wherein the second authentication process involves the use of fewer authentication factors than the first authentication process.

3. The method of claim 1, comprising receiving one or more first authentication process credentials for use in the first authentication process.

4. The method of claim 3, comprising transmitting the one or more first authentication process credentials via an interface to a bank data processing system.

5. The method of claim 1, comprising:
receiving one or more first authentication process credentials for use in the first authentication process prior to said receiving of the authentication-indicative data from the bank data processing system; and
transmitting said one or more first authentication process credentials to the bank data processing system prior to said receiving of the authentication-indicative data from the bank data processing system.

6. The method of claim 1, comprising transmitting a request for one or more third authentication process credentials for use in a third authentication process conducted between the user and the bank data processing system.

7. The method of claim 1, comprising:
transmitting a request for one or more third authentication process credentials for use in a third authentication process conducted between the user and the bank data processing system in response to determining that a payment authorization request involving the user relates to potentially fraudulent activity;
receiving one or more third authentication process credentials for use in the third authentication process after said receiving of the authentication-indicative data from the bank data processing system; and
transmitting said one or more third authentication process credentials for use in said third authentication process conducted between the user and the bank data processing system after said receiving of the authentication-indicative data from the bank data processing system.

8. The method of claim 1, comprising:
transmitting a request for further payment data associated with one or more transactional accounts held by the user with the bank data processing system to the bank data processing system in response to detecting one or more trigger events;
receiving further payment data associated with one or more transactional accounts held by the user with the bank data processing system from the bank data processing system; and
storing the further payment data in the data store in association with the user account,
wherein the one or more trigger events comprise one or more of:
receiving a request from the user to determine whether updated payment data is available;
expiry of a predetermined time period;
determining that payment data stored in association with the user account is no longer valid.

9. The method of claim 1, wherein payment data associated with a plurality of transactional accounts held by the user is stored in the data store in association with the user account, the method comprising transmitting data identifying the plurality of transactional accounts to an online merchant system associated with an online merchant to facilitate selection of a preferred transactional account by the user.

10. A system for use in processing payment authorization requests for payment transactions to be conducted via a data communications network, the system comprising a trusted intermediary system configured for:
receiving data indicative of a user having been authenticated by a first authentication process conducted between the user and a data communication interface associated with a bank data processing system via a data communication network;
activating, in response to the receipt of the authentication-indicative data, a user account corresponding to one or more transactional accounts held by the user at the bank data processing system;
storing payment data associated with the one or more transactional accounts in a data store in association with the user account; and
retrieving, following a subsequent authentication of the user by a second authentication process conducted between the user and the trusted intermediary system, the stored payment data from the data store for use in processing at least one payment authorization request involving the user.

11. A non-transitory computer-readable medium comprising computer-executable instructions which, when executed by a processor, cause a computing device to perform a method for use in processing payment authorization requests for payment transactions to be conducted via a data communications network, the method comprising, at a trusted intermediary system:
receiving data indicative of a user having been authenticated by a first authentication process conducted between the user and a data communication interface associated with a bank data processing system via a data communication network;
activating, in response to the receipt of the authentication-indicative data, a user account corresponding to one or more transactional accounts held by the user at the bank data processing system;
storing payment data associated with the one or more transactional accounts in a data store in association with the user account; and
retrieving, following a subsequent authentication of the user by a second authentication process conducted between the user and the trusted intermediary system, the stored payment data from the data store for use in processing at least one payment authorization request involving the user.

12. A method for use in processing payment authorization requests for payment transactions to be conducted via a data communications network, the method comprising, at a bank data processing system:
conducting a first authentication process involving a user and the bank data processing system; and
transmitting data, indicative of the user having been authenticated by the first authentication process, to activate a user account for the user in a trusted intermediary system, the trusted intermediary system being arranged to store payment data associated with one or more transactional accounts held by the user at the bank data processing system in a data store in association with the activated user account and to retrieve, following a subsequent authentication of the user by a second authentication process conducted between the user and the trusted intermediary system, the stored payment data from the data store for use in processing at least one payment authorization request involving the user.

13. The method of claim 12, wherein the second authentication process involves the use of fewer authentication factors than the first authentication process.

14. The method of claim 12, comprising:
receiving one or more first authentication process credentials for use in the first authentication process.

15. The method of claim 14, comprising:
receiving the one or more first authentication process credentials via an interface with the trusted intermediary system.

16. The method of claim 12, comprising:
receiving the one or more first authentication process credentials for use in the first authentication process prior to transmitting the authentication-indicative data to the trusted intermediary system.

17. The method of claim 12, comprising:
transmitting a request for one or more first authentication process credentials for use in a third authentication process conducted between the user and the bank data processing system to the trusted intermediary system in response to determining that a payment authorization request involving the user relates to potentially fraudulent activity.

18. The method of claim 12, comprising:
receiving one or more first authentication process credentials for use in a third authentication process conducted between the user and the bank data processing system after transmitting the payment data to the trusted intermediary system.

19. The method of claim 12, wherein the first authentication process is different from the second authentication process.

20. The method of claim 12, comprising:
transmitting updated payment data associated with one or more transactional accounts held by the user with the bank data processing system from the trusted intermediary system in response to detecting one or more trigger events,
wherein the one or more trigger events comprise one or more of:
receiving a request from the user to provide updated payment data to the trusted intermediary system;
expiry of a predetermined time period;
determining that at least some payment data associated with the one or more transactional accounts held by the user with the bank data processing system is no longer valid.
